(19) United States
(12) Patent Application Publication
(10) Pub. No.: US 2011/0119702 A1
(43) Pub. Date: May 19, 2011

(54) ADVERTISING METHOD USING NETWORK TELEVISION

(76) Inventors: Sae Hun Jang, Seoul (KR); Uni Young Kim, Seoul (KR); Sang Jun Koo, Seoul (KR); Kyung Hee Yoo, Seoul (KR); Hyung Nam Lee, Seoul (KR)

(21) Appl. No.: 12/764,667

(22) Filed: Apr. 21, 2010

(30) Foreign Application Priority Data
Nov. 17, 2009 (KR) 10-2009-0110821

(51) Int. Cl. H04N 7/025

(52) U.S. Cl. 725/32

(57) ABSTRACT

An information manager includes a network interface, a user interface, and a controller. The network interface establishes a connection with a content provider or network operator and receives content and one or more advertisement images through the network. The user interface receives a signal initiated by a user. And, the controller controls display of a plurality of icons and a background image that includes at least one advertisement region. One of the advertisement images is displayed in the region and one of the icons corresponds to the content provider.

### CROSS-REFERENCE TO RELATED APPLICATIONS

The present application claims the benefit of priority under 35 U.S.C. 119 to Korean Patent Application No. 10-2009-0110821 filed on Nov. 17, 2009 which is hereby incorporated by reference in its entirety.

### BACKGROUND

1. Field

Embodiments disclosed herein relate to display of media information.

2. Background

As digital technology develops, the concept of providing internet content on various types of display devices has garnered a lot of attention. One technology proposed for this purpose is Internet Protocol TV (IPTV), which seeks to transmit video, audio, and other forms of digital content to televisions through a high-speed internet connection.

Other forms of technology include broadband TV and web TV. Unlike IPTV, broadband and web TV provide media information (e.g., VOD, game, visual telephone services, etc.) from several content providers. However, the aforementioned technologies as presently constituted have failed to optimize the delivery of content to television users, nor do they offer users with creative ways of controlling and navigating through the selection, viewing, and previewing of internet content and of reviewing advertisement information.

### BRIEF DESCRIPTION OF THE DRAWINGS

FIG. 1 is a diagram showing one embodiment of a network TV system.

FIG. 2 is a diagram showing one possible configuration of a network TV that may be included in the system of FIG. 1.

FIG. 3 is a diagram showing another possible configuration of the network TV that may be included in the system of FIG. 1.

FIGS. 4 and 5 show examples of a remote controller that may be used to control the network TV shown, for example, in at least FIG. 2.

FIG. 6 is a diagram showing an example of an interface unit of the network TV shown in FIG. 1 and a motion recognition remote controller of FIG. 3.

FIG. 7 is a diagram showing an example of a menu screen that may be generated on one or more of the embodiments of the network TV described herein.

FIGS. 8 and 9 are diagrams showing operations in one embodiment of a method for generating the menu screen in FIG. 7.

FIGS. 10 to 15 are diagrams showing operations included in one embodiment of a method for applying various effects (such as a video, using data relating to icons selected) in association with a menu screen generated in accordance with one or more embodiments described herein.

FIG. 16 is a flowchart showing operations included in one embodiment of method of displaying video based on selection of an icon in a menu screen.

FIGS. 17 to 20 are diagrams showing operations included in embodiments of a method for displaying a message or an advertisement image in one or more image display regions of a background image.

FIG. 21 is a diagram showing operations included in another embodiment of a method for displaying a message or an advertisement image in an image display region of a background image.

FIGS. 22 and 23 are diagrams showing examples of effects that may be performed on the menu screen described herein.

FIG. 24 is a diagram showing operations included in one embodiment of a method for performing one or more effects.

FIGS. 25 to 30 are diagrams showing operations included in one embodiment of a method for changing a background image.

FIG. 31 is a diagram showing operations included in another embodiment of a method for changing a background image.

FIGS. 32 to 34 are diagrams showing operations included in one embodiment of a method for displaying problems associated with operation of a network TV as described herein.

FIG. 35 is a diagram showing operations included in another embodiment of a method for displaying problems associated with operation of a network TV.

FIGS. 36 and 37 are diagrams showing operations included in one embodiment of a method for displaying advertising movie contents.

FIG. 38 is a diagram showing operations in another embodiment of a method for displaying an advertisement.

FIG. 39 is a diagram showing another embodiment wherein a television signal is displayed at a same time a menu screen is displayed containing a background image and menu of content provider icons.

### DETAILED DESCRIPTION

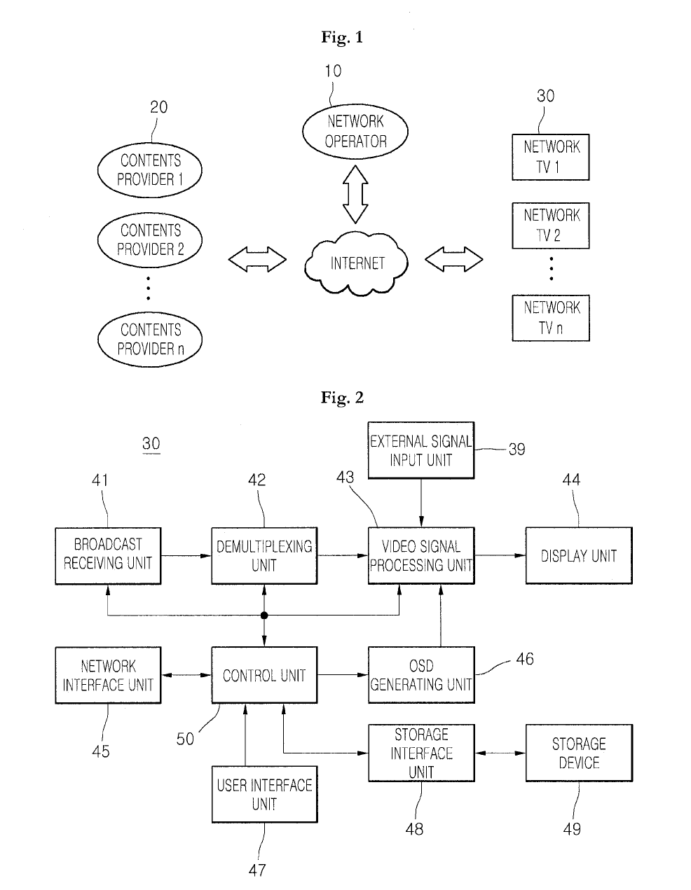

FIG. 1 shows a network configuration of one embodiment of a network TV system, which includes a network operator 10, at least one content provider (CP) 20, and at least one network TV 30, which are connected by a network which, for example, may be the internet.

The network operator 10 provides base software, middleware, firmware, or other instructions for assisting in operation of content provided by content provider 20 in the network TV 30, as well as software for operation of the network TV 30. The content provider may include hardware information corresponding to the network TV needed for normal execution of contents in the network TV.

For example, network operator 10 may provide a basic screen frame needed to provide the contents provided by the content provider to the network TV, and also may provide a user interface for allowing for a user to select content, input various commands, or display corresponding output. Further, network operator 10 may also provide data for updating firmware or software of the network TV. The network operator may correspond to or be based on the manufacturer of the network TV or may be another type of operator.

The contents provider 20 generates various contents that can be provided on the network, arranges or otherwise forms the content in a format that can be played on the network TV, and then provides the contents in accordance with a request of the network TV. The content may be any type of multimedia content which, for example, is capable of being serviced or otherwise provided through the network.

According to one embodiment, the content of content provider 20 may be directly provided to the network TV through the internet by the contents provider and/or may be provided to the network TV 30 the network operator 10.

The network TV may be provided with exclusive firmware for displaying playing content, searching, and/or displaying a list for each content provider. The firmware may be installed in the network TV during manufacturing the network TV or may be downloaded from the contents provider or network operator and then installed when being used by a user.

The firmware of the network TV may include a program for playing or executing content provided by content provider. The firmware may be changed in accordance with the types of contents provided by the content provider. For example, when the content provider is a video-on-demand (VOD) provider, the firmware may be a VOD play program. When the content provider is an AOD and/or MOD provider, the firmware may include an AOD and MOD play program. When the content provider is a visual telephone provider, the firmware may include a visual telephone program.

The network TV receives and then plays or executes content from the content provider. The network TV may be a TV equipped with a network module, a broadcast receiver such as a set top box, and/or any display device equipped with a network module such as a telephone for a network. Although a broadcast receiver is discussed herein, other embodiments may include or correspond to any type of display device that can connect to a network.

In addition, content provider 20 may be a provider who makes or distributes a variety of content. For example, the content provider may include a TV broadcasting station, a radio station, a VOD provider, an AOD provider, a game provider, a visual telephone provider, a weather information provider, or a photograph-related service provider, as well as other type of content providers.

The TV broadcasting station may be a terrestrial or cable broadcasting station and this broadcasting station can produce and store programs that users can watch and convert them into a digital type and then transmit them.

The radio broadcasting station may provide audio content with or without video content.

The VOD provider and AOD provider may have different characteristics from a TV or radio broadcasting station. For example, the VOD or AOD provider may provide a service that allows a user to store and play desired broadcast programs, movies, and music. If a user has no time to watch a desired program, the user may be allowed to download or play a desired media file to allow it to be watched by connecting to a site that provides this broadcasting service. The AOD provider may provide a streaming service of audio content.

The MOD (Music On Demand) service provider may allow a user to download music to listen to the music.

The visual telephone provider may provide a relay service such that a user can make a visual telephone call with a user of another network TV through a network. The weather information provider may provide information on several local areas and the photograph-related service provider provides a tool for editing and storing photographs.

In addition, the content provider 20 may be any server operator who can provide one or more services to the network TV through the internet such as but not limited to a PF (Packet Filter) server, an EPG service provider, an ECG (Electronic Content Guide) service provider, and a portal server operator, etc.

The PF server may be serviced by an enterprise that manages by deputy all broadcasting information and location information, etc., which are provided by the content provider. This service usually contains broadcasting time of a corresponding broadcasting station, location information needed for broadcasting, and information that a user can contact.

The EPG service may provide EPG information to allow a user to search broadcast programs for each time period and find them for each channel.

The ECG service may provide a user with information on content offered by the content provider, the location of a connection server, and/or access authority to the connection server. For example, the information may be an electronic program guide that provides in detail a function that allows for connecting to servers having the contents and information of the contents.

The portal server may be a web service provided from each broadcasting station, and may be connected to a web server of a broadcasting station or an enterprise that services content when, for example, receiving a request from a user or user terminal or TV. The function of the portal server may allow a program list to be searched, which program list may be provided respective broadcasting stations or content providers who provide content services.

The network TV may be equipped or coupled to a network interface for connecting with one or more networks, receiving and processing data packets through the network(s), using, for example, an assigned IP address and may store or play data packets when data packets contain multimedia data, such as video and/or audio data.

In accordance with one embodiment, the network TV may bilaterally transmit a user request signal while processing multimedia data. Further, buttons for controlling the network TV (e.g., buttons for selecting various on-screen menus) may be provided in an input device (such as a remote controller or spatial pointing device) or an operational button for controlling the network TV.

FIG. 2 shows one possible configuration of network TV 30. Other than the function of receiving contents through a network, the network TV may be provided with a function of receiving RF signal type broadcast signals by wireless communication or through a cable, using the broadcast receiving unit 41.

According to one embodiment, the network TV may include a broadcast receiving unit 41, a demultiplexing unit 42, a video signal processing unit 43, a display unit 44, a network interface unit 45, an OSD generating unit 46. a user interface unit 47, a storage interface unit 48, a storage device 49, an external signal input unit 39, and a control unit 50.

The broadcast receiving unit 41, demultiplexing unit 42, and video signal processing unit 43 may constitute one broadcast process unit that receives broadcast signals and processes them into a type which can be outputted to display unit 44, by performing various processes. When contents are provided by digital broadcasting, digital broadcast signals are transmitted in transport stream type packetized by time-division multiplexing video signal, audio signals, and addition data.

The broadcast receiving unit 41 may include an antenna receiving broadcast signals transmitted from the outside, and may also include a tuner that tunes a broadcast signal having a corresponding frequency band in accordance with a tuning control signal of control unit 50, which is described below, and a demodulator that outputs the broadcast signal of a predetermined tuned channel by performing a VSB (Vestigial Sideband) modulating process and an error correcting process to the broadcast signal.

The broadcast signal received by the broadcast receiving unit is divided into various additional data defined as a video signal, an audio signal, and a PSIP (Program and System Information Protocol) information etc. by demultiplexing unit 42 and then outputted in a bit stream type. The video data separated by the demultiplexing unit is processed by the video signal processing unit and displayed by the display unit.

In this configuration, the video signal processing unit includes an MPEG-2 decoder and a scaler that converts the video data to meet vertical frequency, resolution, screen ratio, etc., corresponding to output standards of the display unit. The display unit may be one of various types of displays such as a DLP (Digital Light Processing), an LCD (Liquid Crystal Display), PDP (Plasma Display Panel), as well as others.

Further, the audio signal may be processed by a voice signal processing unit (not shown) and outputted from a speaker, in which the voice signal processing unit may include an AC-3 decoder.

On the other hand, the additional data included in the additional data separated by the demultiplexing unit is stored in storage device 49 through the storage interface unit 48, which is described below. The storage device may be an EEPROM (electrically erasable programmable read-only memory) or another type of memory or storage device.

The user interface unit may be a circuit for receiving a request instruction from a user and may include, for example, an infrared receiving unit that receives an infrared signal inputted by a remote controller or a local key input unit disposed at one side of a panel. An RF or other type of interface may alternatively be used.

The network interface unit 45 receives contents or data from content provider 20 or network operator 10 through the network. That is, the interface unit may receive content such as broadcast, games, VODs, broadcast signals, provided from the contents provider and the associated information. Further, it also receives the updated information of a firmware and updated which the network operation provides through network interface unit 45.

The OSD generating unit 46 may generate a menu screen for receiving the user determination signal in an OSD (On Screen Display) type. That is, the OSD generating unit may display content received through network interface unit 45 and the associated information through the display unit.

The external signal input unit 39 is an interface that may receive an input from other players, for example, DVD players, game machines, etc. It is possible to output multimedia stored in other players to the display unit 44 by connecting the players to the external signal input unit.

The control unit 50 controls the overall operations in accordance with the instructions inputted from the user interface unit 47. The control unit may receive and executes software of content provider 20 received from network operator 10, e.g., an updated file of the firmware.

According to one embodiment, broadcast receiving unit 40 may output a three-dimensional (3D) image or representation. The menu screen of the broadcast receiving unit 40 can be provided in 3D and can also receive and output 3D-contents, when the content provided by content provider 20 is 3D-contents. Additional processing circuits or other components may be included to output the 3D image or contents.

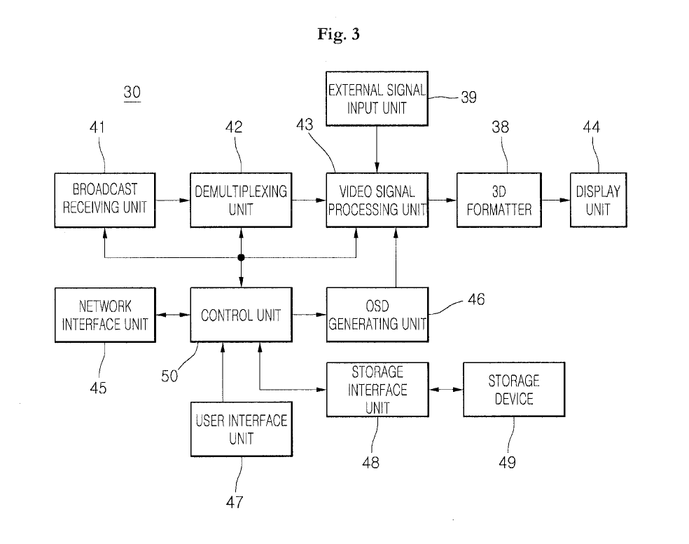

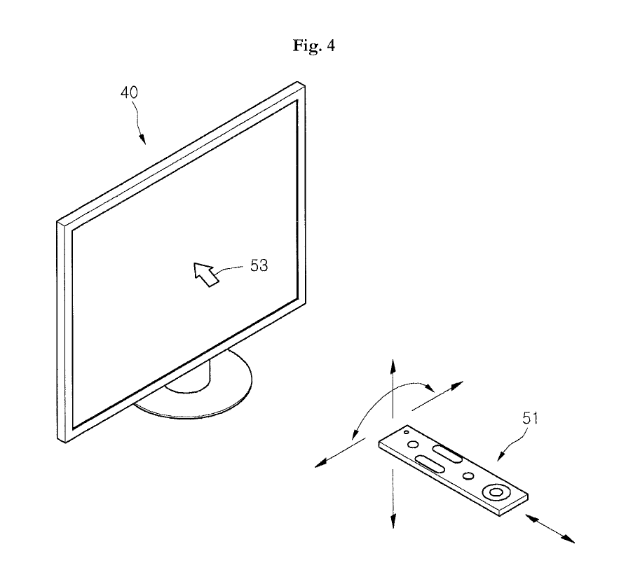

FIG. 3 shows one example of a broadcast receiving device that can process a 3D-image. The operation of the other components except 3D-formatter 38 may be the same as that of FIG. 2.

As shown in FIG. 3, 3D-formatter 38 may be disposed at an output end of video signal processing unit 48. The 3D-formatter converts the image processed by the video signal processing unit into a 3D-image and transmits it to display unit 44. According to one embodiment, a specific 3D-formatter that converts an OSD output into 3D may be included in OSD generating unit 46. Other processing systems may be used in alternative embodiments.

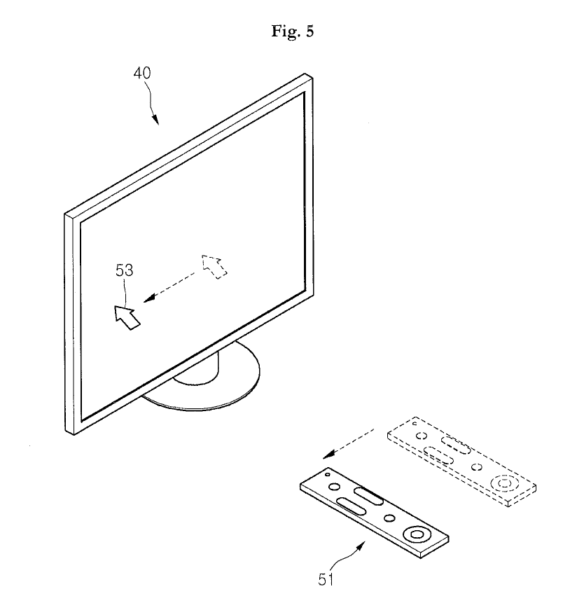

FIGS. 4 and 5 show an example of a remote controller for controlling the network TV of FIG. 2 or 3. The remote controller can transmit a control signal to control unit 50 through a wireless signal receiver that can be included in user interface unit 47 of the network TV and receives wireless signals such as an RF signal or an infrared signal. The remote controller described with reference to FIGS. 4 to 5 is a remote controller that responses to not only a button input by a user, but a user's gesture, and which is referred to as a motion recognition remote controller 51 hereafter.

According to one embodiment, the motion recognition remote controller 51 may transmit/receive a signal to/from the network TV in accordance with an RF communication regulation. As shown in FIG. 4, a pointer 53 can be displayed at a position pointed by the motion recognition remote controller 51 on the network TV.

A user can move or rotate the motion recognition remote controller 51 up/down, left/right, and forward/backward. The pointer 53 displayed on the network TV responds to the movement of the motion recognition remote controller.

FIG. 5 shows when a pointer displayed on the network TV moves in response to the movement of the motion recognition remote controller.

As shown in FIG. 4, when a user moves motion recognition remote controller 51 to the left, the pointer displayed on the network TV correspondingly moves to the left. The motion recognition remote controller may have a sensor that can recognize movement in this embodiment. Information on the movement of the motion recognition remote controller which has been detected by the sensor of the motion recognition remote controller is transmitted to the network TV. The network TV determines the movement of the motion recognition remote controller based on the information on the movement of the motion recognition remote controller and calculates corresponding coordinates of pointer 53. An acceleration sensor, a gyrosensor, or a geomagnetic sensor can be used for the sensor that can recognize movement.

FIGS. 4 and 5 show an example when pointer 53 displayed on display 49 moves in response to up/down and left/right movement or rotation of motion recognition remote controller 51. The movement velocity or direction of the pointer may respond to the movement velocity or direction of the motion recognition remote controller.

In this embodiment, a pointer displayed on the network TV is set to move in response to motion of motion recognition remote controller 51. According to another example, a predetermined instruction may be input into the network TV in response to motion of the motion recognition remote controller. That is, when the motion recognition remote controller moves forward/backward, the size of an image displayed on the network TV can be increased or decreased.

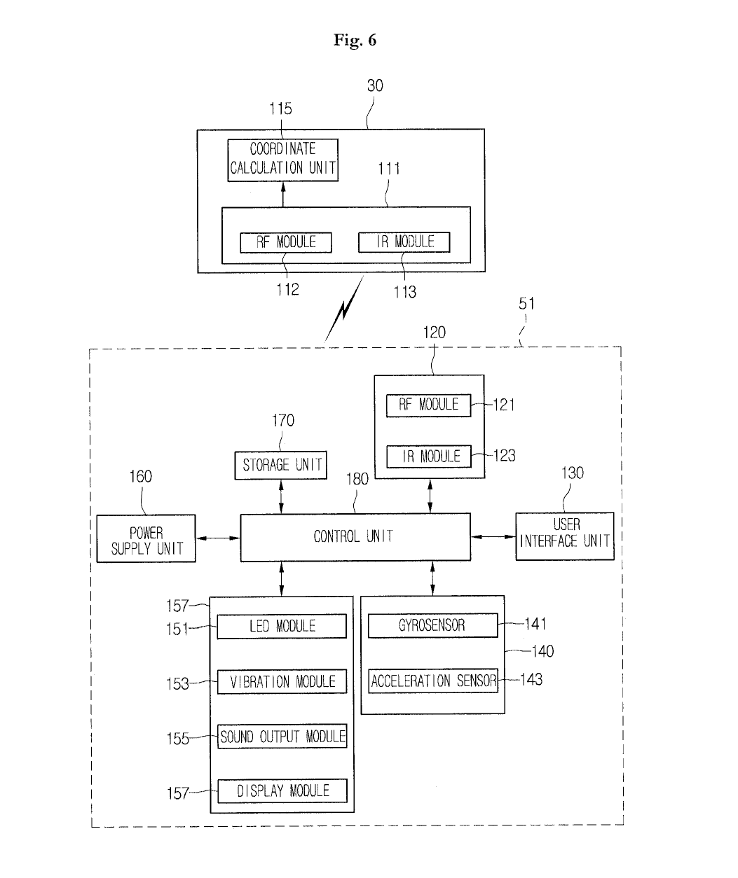

FIG. 6 shows an example of how an interior portion of interface unit 47 of the network TV of FIG. 1 and remote controller 51 of FIG. 4 may be configured.

As shown, the network TV may include a coordinate calculation unit 115 and a wireless communication unit 111. The coordinate calculation unit may be included in control unit 50, and the wireless communication unit may be included in the user interface unit. The wireless communication unit may include an RF module 112 or IR module 113.

The motion recognition remote controller 51 may include a wireless communication unit 120, a user input unit 130, a sensor unit 140, an output unit 150, a power supply unit 160, a memory 170, and a control unit 180.

The wireless communication unit 120 transmits/receives a signal to/from the network TV. In this embodiment, the motion recognition remote controller may have an RF module 121 that can transmit/receive a signal to/from the interface unit 40 of the network TV under the RF communication regulation. Further, the motion recognition remote controller may have an IR module 123 that can transmit/receive a signal to/from the interface unit 40 of the network TV under the IR communication regulation.

In this embodiment, motion recognition remote controller 51 transmits a signal carrying information on motion of the motion recognition remote controller to the network TV, using RF module 121. Further, the motion recognition remote controller can receive a signal transmitted from the network TV using the RF module. Further, the motion recognition remote controller can transmit, if needed, an instruction about power-on/off, a channel change, a volume change etc. to the network TV using IR module 123.

The user input unit 130 may include a key pad or buttons. A user can input an instruction relating to the network TV, using motion recognition remote controller 51, by operating user input unit 130. When the user input unit has a hard key button, a user can input an instruction relating to the network TV, using the motion recognition remote controller, by pressing the hard key button.

If the user input unit has a touch screen, a user can input an instruction relating to the network TV, using the motion recognition remote controller, by touching the soft key of the touch screen. Further, the user input unit may have a variety of input devices that a user can operate such as, for example, a scroll or jog key or other input device.

The sensor unit 140 may include a gyrosensor 141 or an acceleration sensor 143 as a motion sensor. The gyrosensor may detect movement of motion recognition remote controller 51. For example, the gyrosensor can senses information on movement of the motion recognition remote controller about x-, y-, and z-axes. The acceleration sensor 143 can sense information on movement velocity, etc., of the motion recognition remote controller. The output unit 150 can output an image or voice signal corresponding to operation of user input unit 130 or a signal transmitted from the network TV. A user can recognize whether the user input unit is operated or the network TV is controlled, from output unit 150.

For example, the output unit may have an LED module 151 that is turned on/off, a vibration module 153 that vibrates, a voice output module 155 that outputs voice, and/or a display module 157 that outputs video, when user input unit 130 is operated or the network TV transmits/receives a signal to/from wireless communication unit 120.

The power supply unit 160 supplies power to the motion recognition remote controller. The power supply unit may reduce the waste of power by stopping supplying power, when the motion recognition remote controller does not move for a predetermined period of time. The power supply unit may start again to supply power, when a predetermined key of the motion recognition remote controller is operated.

The memory 170 can store various types of application data for operating or controlling motion recognition remote controller 51. If the motion recognition remote controller transmits/receives a signal by wireless to/from the network TV, using RF module 121, the motion recognition remote controller and network TV transmit/receive a signal in a predetermined frequency band. The control unit 180 of the motion recognition remote controller can store information on the frequency band where wireless communication of a signal with the network TV paired with the motion recognition remote controller to memory and refers to it.

The control unit 180 may perform operations relating to controlling motion recognition remote controller 51. For example, the control unit can transmit a signal corresponding to the operation of a predetermined key of user input unit 130 or a signal corresponding to the operation of the motion recognition remote controller sensed by sensor unit 140, to wireless communication unit 111 of the network TV, using wireless communication unit 120.

As previously described, the network TV may operation with the wireless communication unit that may transmit/receive a signal by wireless to/from motion recognition remote controller 51 and coordinate calculation unit 115 that can calculate coordinates of the pointer, which correspond to motion of the remote controller.

The wireless communication unit 111 may transmit/receive a signal by wireless to/from the motion recognition remote controller, using the RF module 112. Further, it can receive a signal transmitted from the motion recognition remote controller, using the RF module, under the IR regulation.

The coordinate calculation unit 115 can calculates coordinates (x,y) of pointer 53 that will be displayed on display 49 by correcting hand tremble or an error, on the basis of a signal corresponding to motion of the motion recognition remote controller which has been received through the wireless communication unit.

Further, the signal transmitted from the motion recognition remote controller to the network TV through interface unit 40 is transmitted to control unit 47 of the network TV. The control unit recognizes information on key operation and motion of the motion recognition remote controller on the basis of the signal transmitted from the motion recognition remote controller and may control the network TV on the basis of the recognized result.

An example of a menu screen of the network TV and a method of operating the menu screen will now be described. According to one embodiment, the ‘menu screen’ of the network TV may be an initial screen or a main screen generated when the network TV enters an operation mode (hereafter, referred to as Netcast mode). In this mode, a menu may be generated to allow the network TV to select and connect with one of a plurality of content provider. According to one embodiment, the menu screen may include a plurality of icons 212 representing a plurality of content providers, and may also include a background image 201 having a specific subject.

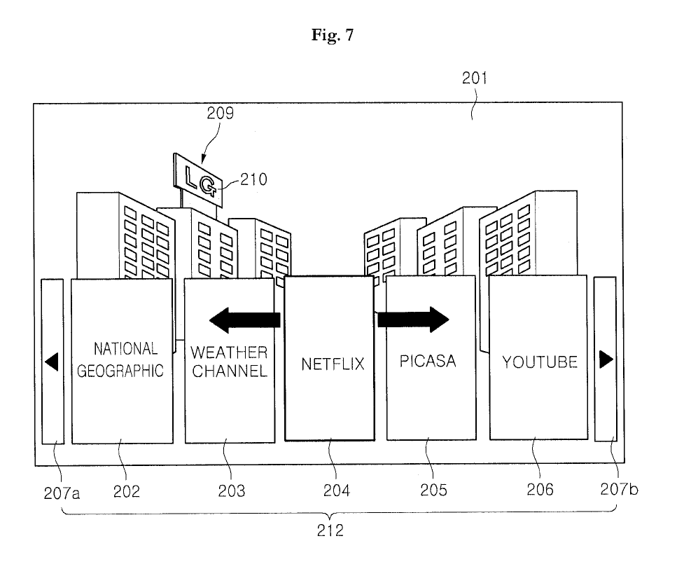

FIG. 7 shows a menu screen as described above. In this screen, an image of a city is shown as background image 201 and icons 212 representing respective content providers are shown over the main screen. The image of the menu screen can have a specific subject, other than the city shown in FIG. 7, and, for example, may have various subjects such as a jungle, a department store, a beach, the universe, and a scene of fairy tales, or virtually any other image and/or theme. For example, the background image can include graphic objects that can be displayed by selectively inserting a basic image and other images corresponding to the subject.

The icons 212 correspond to one or more buttons for connecting with a plurality of content providers and a user can be provided with desired services by selecting one of the icons to connect with the selected content provider. According to one embodiment, the icons may relate to background image 201; that is, the icons may be graphic objects corresponding to one or more subjects, objects or other features in the background image. For example, as shown in FIG. 7, icons 212 may be displayed in the shape of a structure or a signboard on the road of a city. The images displayed on the icons can be provided by the contents providers, respectively.

When the background image is changed in accordance with user information, an area, icons 212 and/or images displayed on the icons can be changed.

A user can use the motion recognition remote controller 51 with reference to FIGS. 4 to 6 in order to select the icons 212.

As an embodiment of content providers, there are displayed icons of contents providers of National Geographic 202, Weather Channel 203, Netflix 204, Picasa 205, and Youtube 206 in FIG. 7. Assume that National Geographic 202 is a content provider that provides contents about the National science, Weather Channel 203 is a content provider that provides weather information, Netflix 204 is a content provider that provides content about movies, Picasa 205 is a content provider that provides content about photographs, and Youtube 206 is a content provider that provides VOD (Video on Demand).

According to one embodiment, various types and/or numbers of icons can be additionally displayed on the menu screen, other than or with the above-described icons. Scroll bars 207a and 207b are disposed at the left and right sides of icons 212, such that additional icons can be displayed when a user selects the scroll bars.

According to one embodiment, an image display region where other image can be displayed is defined at a portion of background image 201, such that it is possible to display other images showing an advertisement image or message in the image display region, if needed. The advertisement image may include an advertisement and other image may include predetermined information of guide messages. The advertisement image or the other images can be provided by the network operator 10 or the content providers 20.

According to one embodiment, the image display region can be disposed a predetermined position on background image 201, and may be disposed at an appropriate position in consideration of the subject of the background image. For example, as shown in FIG. 7, image display region 209 may be disposed at the outdoor signboard position and an advertisement image 210 can be displayed.

The image display region can have various shapes in accordance with the subject of background image 201. For example, when the subject of the background image is a park, the image display region can be disposed at a pond or a tree that can easily seen in the park. When the subject of the background image is a department store, the image display region can be disposed at a show window that can be easily seen in the department store.

As previously described, it is possible to display a message or an advertisement without boring a user, by displaying an image in image display region 209 to be harmonized with background image 201. Detailed and various methods of displaying a message or an advertisement in the image display region are described below.

When a user selects one of icons 212, for example, Netflix icon 204, selected icon 204 is highlighted to be discriminated from the other icons. With the selected icon highlighted, when an arrow button of the motion recognition remote controller is operated or another icon is selected, the highlight can be moved to the new selected icon. With the icon selected, when the ENTER button of the motion recognition remote controller or a button having the function corresponding to it is pressed, it connects with the server of the contents provider corresponding to the selected icon and the initial screen of the server of the contents provider is displayed. The number, size, position, and arrangement of icons displayed on one screen can vary in different embodiments.

Icons 212 can include a name or an image for discriminating the contents providers, and the network TV that is sold by the network TV manufacturer can be sold with the icons built-in. Further, according to an embodiment, while a user purchases and uses the network TV, the network operator 10 of FIG. 1 may be provided with images used for the icons from content providers 20, and then transmit them to the network TV or update them. Further, the network TV may directly connects with the servers of the content providers 20 and download the images.

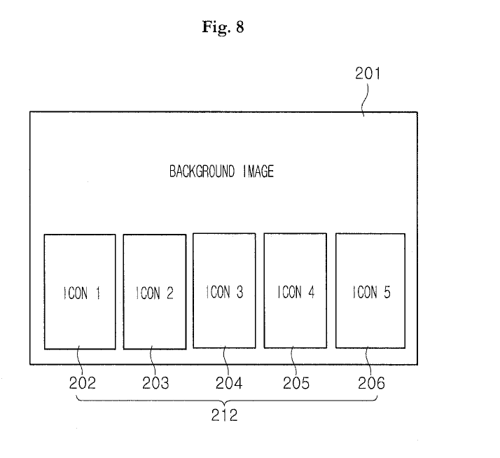

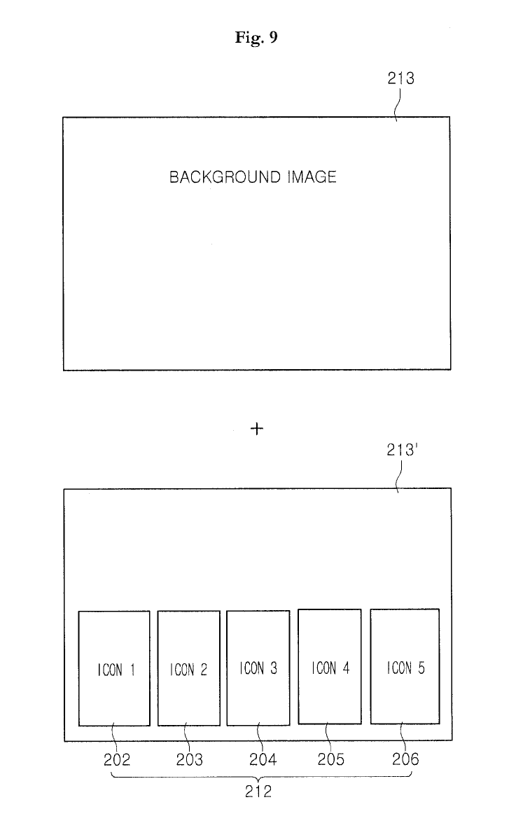

FIGS. 8 and 9 show generation of a menu screen including background images 201 and icons 212 as shown, for example, in FIG. 7. As shown in FIG. 9, the menu screen may include a plurality of icons disposed over the background image. The menu screen can be implemented, for example, by overlapping a layer 213 including the background image and a layer 213′ including icons 212.

According to one embodiment, different effects can be applied to or activated for layers 213 and 213′. For example, only icons 212 may be translucently displayed or only background image 201 may be translucently displayed.

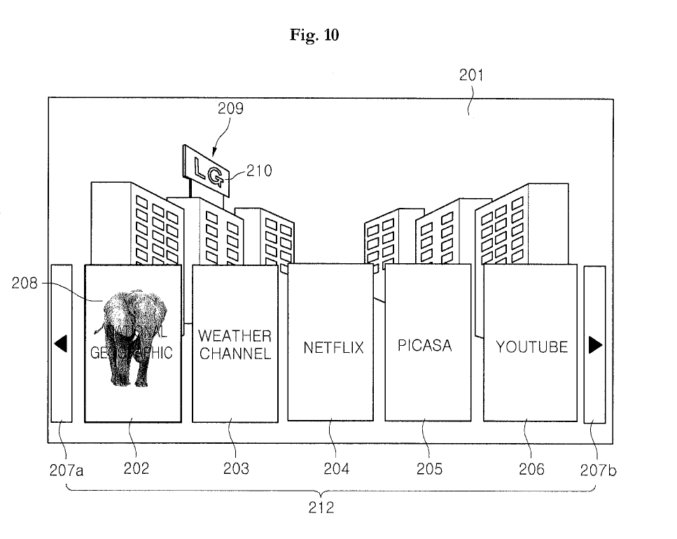

FIGS. 10 to 15 show various effects relating to icons selected by a user to the menu screen, when the user selects icons in the Netcast service mode. The effect may be to display an image relating to the content provider corresponding to the icon, or to display an image that the corresponding content provider can control. The image may be a video or animation or an still image. The image that the contents provider can control is an image directly made by the contents provider or made by another manufacturer by request, and can be transmitted to the network TV, directly or through network operator 10.

Referring to FIG. 10, when a user selects the icon of the contents provider relating to the National science, for example, icon 202 of the National Geographic in the icons, a video relating to the contents provided by the National Geographic can be displayed while current background image 201 and images of the icons 212 are maintained.

For example, since the National Geographic provides contents relating to animals, when National Geographic 202 is selected, a video showing an animal 208, for example, an elephant working out or working on icons 212 can be displayed. Further, a video showing an eagle flying in the sky in background image 201 or a video showing a variety of animals coming out from one side of the screen can be displayed. The above video effects can be implemented, for example, by using a flash or other type of program.

The above videos relate to the contents providers represented by icons 212 or each icon and can be controlled by the content providers. That is, the contents may be directly made by the contents providers or by another manufacturer by request, and can be transmitted through the network operator or directly to the network TV and stored therein.

It is possible to display a video such that an animal image looks like moving in front of structures or around the structures which include icons 212 of the city that is background image 201, by displaying the animation relating to the contents provider as described above. Therefore, a user can acquire intuitive information on the icons selected by himself/herself and have fun.

When a user presses a specific button of the motion recognition remote controller, for example, the ENTER button, or a button corresponding thereto while a video is played, it connects with the server of the contents provider of the National Geographic, such that the initial screen of a network TV service of the National Geographic can be displayed. Thereafter, the user can be provided with contents by selecting the contents provided by the contents provider of the National Geographic.

The above videos are made in a format that can be executed in the network TV by the content provider 20 on the basis of the system information of the network TV provided by manufacturer 40 of the network TV, and then can be provided to the manufacturer of the network TV. The network TV manufacturer can provide a user with a product having the software of the network TV including the corresponding video such that the video can be played. According to an embodiments, the network TV manufacturer may make a video and include it in the software of the network TV.

According to one embodiment, in the network system of FIG. 1, content provider 20 may make a video and transmit it to network operator 10, after receiving the system information of the network TV from the network operator or the network TV manufacturer. The network operator transmits an updated file including the video file to the network TV and then network TV can display the video as described above by executing the updated file. The displayed video can be updated by the above method.

Further, according to one embodiment, it is possible to implement an image, which is displayed when icon 202 is selected, to be changed in accordance with time and seasons. Further, when a contents provider starts to provide new contents, it is possible to display a video relating to the newly provided contents. The video relating to the new contents described above can be displayed by updating the video in the above method. Even if new contents are not provided, it is possible to allow a user to use the Netcast service, without being bored, by periodically updating the video.

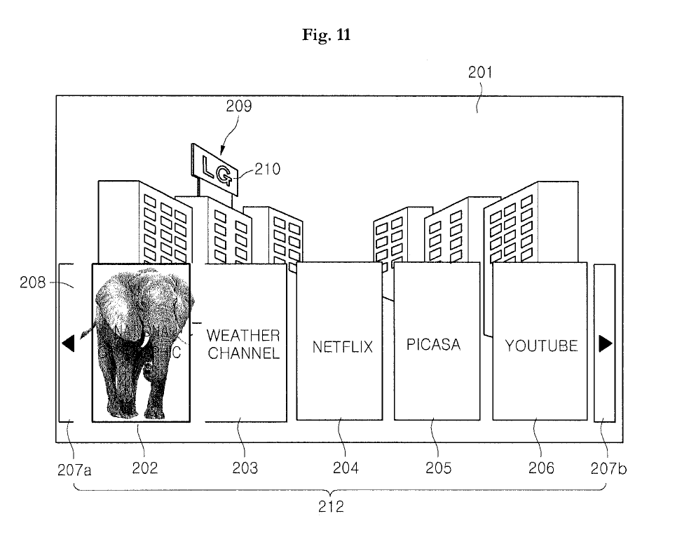

Further, according to an embodiments, it is possible to display an image that is displayed when icon 202 is selected in a 3D-image. For example, when the icon of the National Geographic is selected in FIG. 10, it is possible to provide an effect as if the elephant 208 works out toward a user, as shown in FIG. 11. This embodiment can provide more fun and effect, when icons 212 or background image 201 is implemented in a 3D-image.

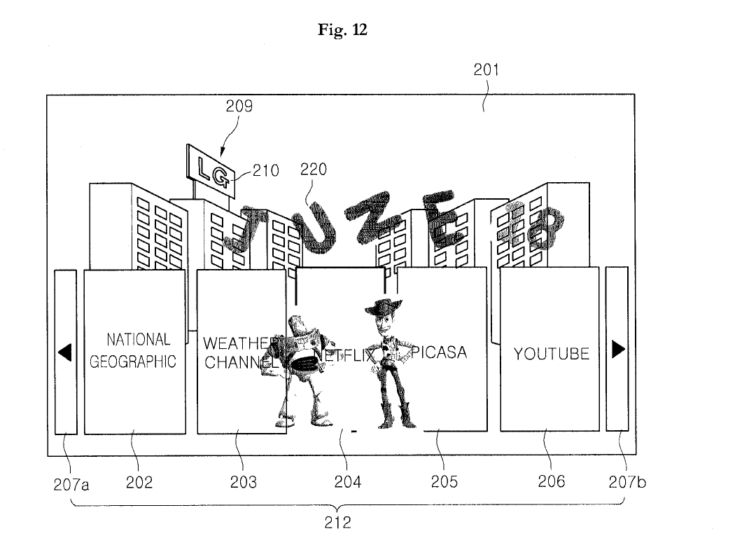

Referring to FIG. 12, according to one embodiment, when a user selects a contents provider about movies, for example, icon 204 of the Netflix, it is possible to display a video relating to the contents provided by the Netflix. It is preferable that the displayed video relates to background image 201 or icons 212. That is, it is preferable that the displayed image is displayed as if it moves in the environment of the city provided by the background image and the icons.

For example, as shown in FIG. 12, it is possible to display a video of the characters of the Toy Story. Further, according to one embodiment, the video may be made to display specific information. For example, assuming that the Netflix plans to service the movie, Toy Story, from a specific date, for example, 18 June, it is possible to display a video in which the characters throw up letters of “J”, “U”, “N”, “E”, “1”, and “8” 220, one by one, over the structures or signboards composed of the icons 212. By the configuration described above, a user can recognize that the selected icon provides a movie content and have fun, while the content provider can advertise specific contents.

The video shown in FIG. 12 can also be displayed by an animation implemented by a flash program, and updated by the method described above. Further, the video of FIG. 12 can also be implemented and displayed in a 3D-image.

Similar to the embodiment shown in FIG. 10, when a user presses a specific button of the motion recognition remote controller, for example, an OK button while a video is displayed, it is possible to display the initial screen by connecting with the Netflix server, and when another button, for example, a cancel button is pressed, the displayed video can be stopped. It is possible to display information on the displayed video, that is, the Toy Story, on the initial screen provided when connecting with the Netflix server.

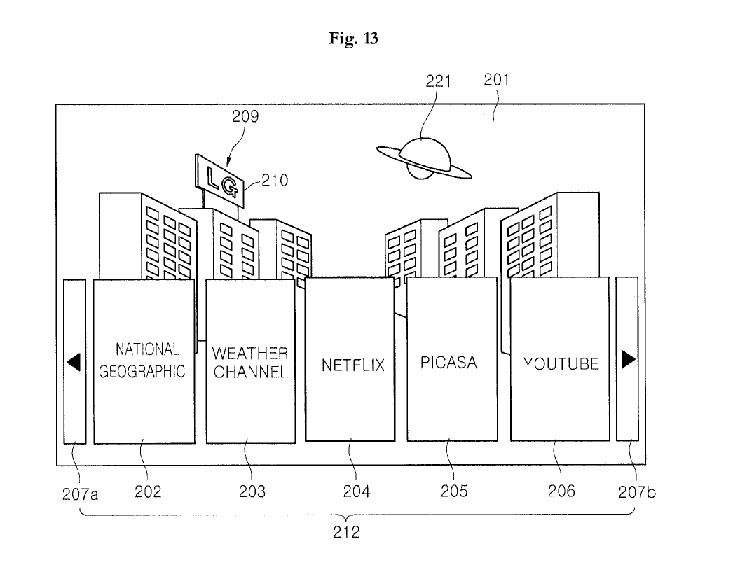

Referring to FIG. 13, when a user selects icon 204 of Netflix that is a content provider of movies, it is possible to display a video in which an object in a predetermined movie, for example, a spaceship 221 of “StarWars” flies in the sky of the background image.

When the user presses a specific button while the spaceship flies, it is possible to connects with the Netflix server and displays the initial screen of the Netflix. It is possible to display the detailed information on the displayed video, that is, the movie relating to the spaceship, that is, StarWars, or an advertisement video (trailer), on the initial screen of the Netflix. It is possible to display the price of the contents of StarWars after the advertisement video is finished, and it is possible to provide the movie content of StarWars to the network TV, when the user decides to purchase the contents.

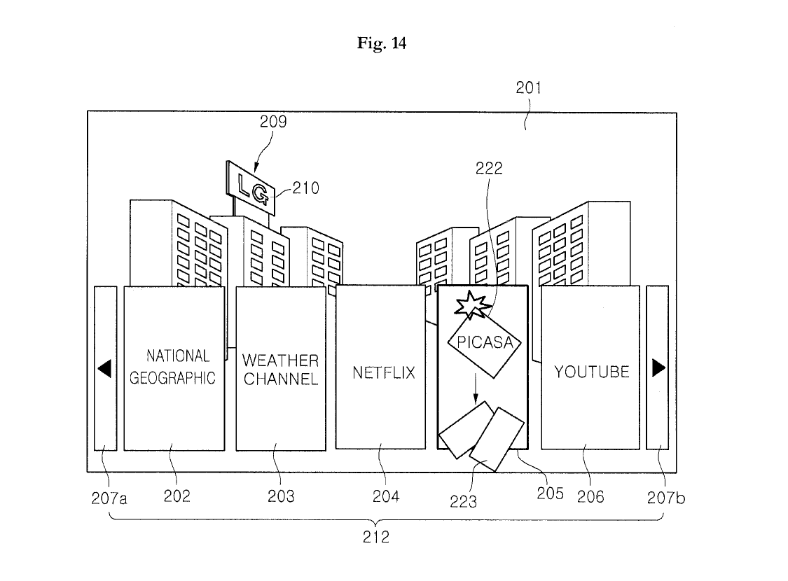

Referring to FIG. 14, when a user select the content provider about photographs, for example, icon 205 of the Picasa, a video relating to photographs can be displayed. Similar to the embodiment described above, It is preferable that the displayed video relates to the background image 201 or the icons 212 constituting the main screen.

For example, when a user selects the Picasa icon, the sound that is generated when taking a photograph can be outputted with a photograph frame 222 displayed in icon 205. Further, it is possible to implement a configuration in which the photograph frame 222 falls down and stacked at the lower end 223 of the icon 205. Similarly, when the user presses the OK button in the above state, it connects with the Picasa server and the initial screen of the Picasa is displayed.

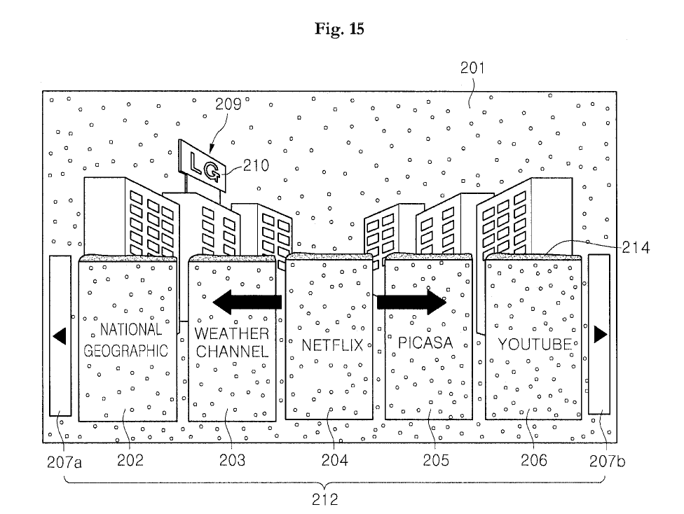

FIG. 15 shows an example of displaying a video relating to weather over the background image 201, when a user selects the contents provider about weather, that is, the icon 203 of the Weather Channel, according to an embodiment of the present invention. FIG. 15 shows when a video in which it snows over the city background image 201 of the menu screen is displayed.

It is possible to receive the weather information on the area where the current network TV is positioned from the weather contents provider and then show the weather in the city in the background image 201. For example, an image where a sun is high can be displayed over the background image when the it is clear, the screen can be made dark by displaying a cloud image when the is cloudy, an image showing it rains can be displayed when it rains, or an image showing it snows can be displayed when it snows, as shown in FIG. 15.

The weather information depends on the area information of the network TV, that is, the position. The weather information contents provider has all the weather information of the service area, and receives the position information of the network TV and then transmits weather codes corresponding to the information to the network TV. The network TV stores a video corresponding to each weather code, and loads and displays a video corresponding to a weather code received from the weather information contents provider, when a user selects the Weather Channel icon 203.

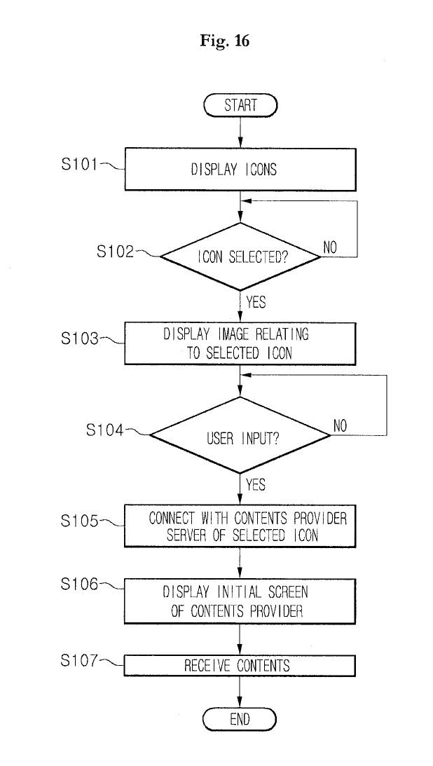

FIG. 16 is a flowchart showing operations included in one embodiment of a method of displaying a video in accordance with a selected icon, in the menu screen including the background image 201 and the icons 212.

In step S101, a menu screen including icons representing contents providers is displayed. The background image can be displayed with the icons.

In step S102, one of the icons is selected by a user. It keeps standing by if there is no user's input.

In step S103, an image relating to the icon selected by the user is displayed, with the background image and the icons still displayed. The image may be a video, an animation, or a still image, and may relate to the contents provider represented by the selected icon or contents that are provided by the contents provider. For example, as described with reference to FIGS. 10 to 15, the image may be a video that relates to the icon or the corresponding contents provider, is provided by the corresponding contents provider, or can be controlled by the content provider.

In step S104, when there is a user input while the image is displayed, in step S105, it connects with the server of the content provider of the selected icon. When there is no user input, the image can be kept repeatedly displayed, or a plurality of different videos may be sequentially displayed.

In step S106, the initial screen of the contents provider server is displayed, and in step S107, contents are provided in accordance with the service that is usually provided by the network TV.

Meanwhile, according to one embodiment, an image including a message or an advertisement can be displayed on the menu screen of the network TV, regardless of a user input. The message may be an advertisement image of other images that are provided by network operator 10 or content provider 20.

As described above, background image 201 of the menu screen of the network TV may include an image display region where an image can be displayed, and the image display region may be disposed at a predetermined fixed position or moved to other positions.

A fixed-type display region is disposed at a fixed position on the background image. For example, the image display region 209 of FIG. 7 is set as a fixed type and an image, such as an advertisement, can be selectively displayed in the image display region. The displayed message or advertisement can be changed or updated by the content provider or network operator.

On the other hand, a movable image display region moves on the background image and is not usually displayed on the menu screen, but it can be displayed on the menu screen by generating an interrupt in the control unit of the network TV. A variety of embodiments relating to the image display region are described hereafter.

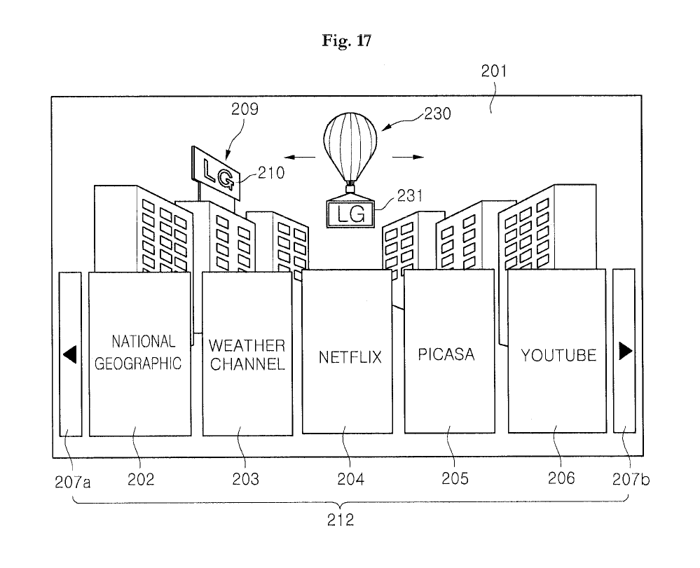

FIGS. 17 to 20 illustrate one embodiment that displays a message or an advertisement, using fixed-type and movable image display regions on a background image.

Referring to FIG. 17, after a predetermined time passes with the menu screen displayed, a predetermined message or advertisement can be displayed on the menu screen, regardless of whether a user selects an icon. The image can be displayed in the movable image display region.

In accordance with one embodiment, the image display region may relate to the subject of background image 201. For example, when the subject of the background image is a city, as shown in FIG. 17, an image display region with a fire balloon 230 flying in the sky can be used. The fire balloon has a box 231 and the box 231 is the image display region where a predetermined message or advertisement can be displayed.

The image representing the movable image display region, that is, the fire balloon and box 231 can be provided by the network operator, and a message or and advertisement image that will be displayed in the movable image display region can be provided by the network operator or the contents provider.

When an advertisement is displayed, the advertiser may be the content provider 20 or any manufacturer. When an advertisement image is displayed in the movable image display region, the advertisement may include an advertisement expression or the company logo. The movable image display region can be implemented by an animation, using a flash program. It is possible to effectively use the above configuration when the network operator or an advertiser wants to display a message or an advertisement to a user.

When the user selects fire balloon 230, using a motion recognition remote controller, or presses a specific button, for example, the ENTER button or a button corresponding thereto while the movable image display region, that is, the fire balloon flies, the detailed information on the corresponding message can be displayed, the home page of the advertiser can be connected and displayed, or an advertisement provided by the corresponding advertiser can be displayed.

On the other hand, an advertisement image 210 was displayed on an outdoor signboard that is the fixed-type image display region 209 in FIG. 17. The advertisement image is provided by the content provider or the network operator and can be changed to fit the image display region. That is, the image display region is tilted, not facing the front in FIG. 17.

The network operator 10 of FIG. 1 is provided with an advertisement expression from the content provider 20 or a predetermined advertiser, and appropriately formats it to fit image display region 209 and then transmits it to the network TV.

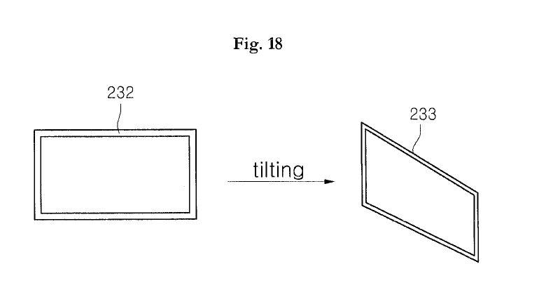

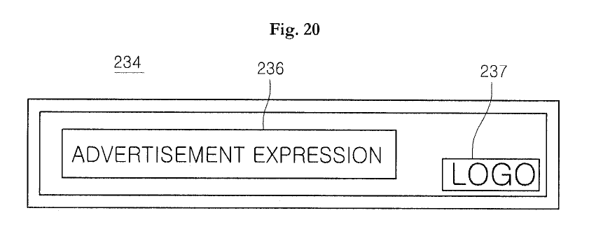

Referring to FIG. 18, original image 232 provided by the content provider or the network operator is a rectangle facing the front, whereas image 233 that will be displayed on the outdoor signboard of FIG. 17 is a tilted image. It is possible to tilt the image provided by the content provider or the advertiser, as shown in FIG. 20, and then transmit it to the network TV.

The fixed-type image display region and the movable image display region described above may be included in the background image. The background image is included in a firmware implementing the menu screen of the network TV, and the position, shape, and size etc. of the image display region can be changed by updating the firmware.

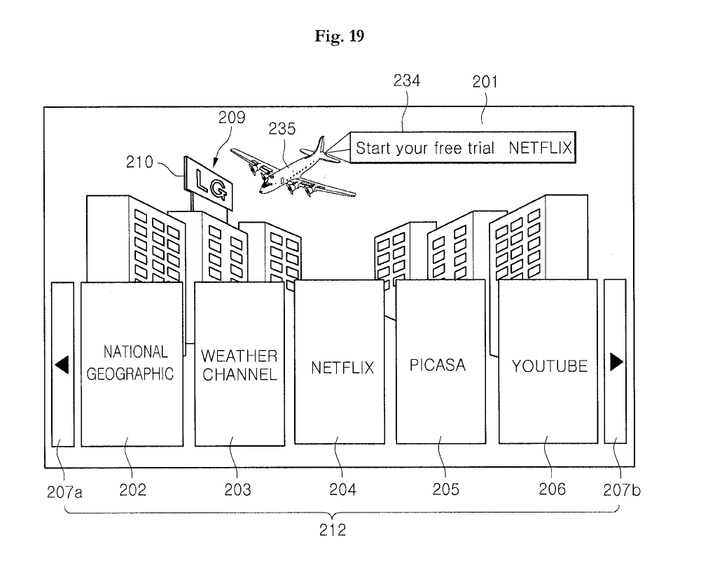

Referring to FIG. 19, according to one embodiment, after a predetermined time passes with the menu screen displayed, it is possible to display a video of an airplane 235 with a banner 234, which is a type of movable image display regions, regardless of whether a user selects an icon. The video of the airplane 235 also relates to the city that is the subject of the background image 201 and displays that the airplane 235 with the banner 234 flies in the sky. Any image can be displayed on the banner.

When the user selects the airplane or presses a specific button, for example, the ENTER button or a button corresponding thereto while the airplane 235 flies, the detailed information on the message displayed on the image can be displayed, detailed information on the advertisement can be displayed, or the TV can connect with the advertiser's server.

According to one embodiment, as shown in FIG. 20, the banner 234 may include a plurality of lower display regions, that is, an advertisement expression slot 236 and a company logo slot 237. It is possible to implement the image in which airplane 235 with banner 234 flies, as shown in FIG. 19, by displaying an advertisement expression and a company logo image provided by the advertiser in the advertisement expression slot 236 and the company logo slot 237.

As in the embodiments described above, the airplane and banner are included in a firmware activating the main screen of the network TV, and the position, shape, and size etc. can be changed by updating the firmware of the network TV.

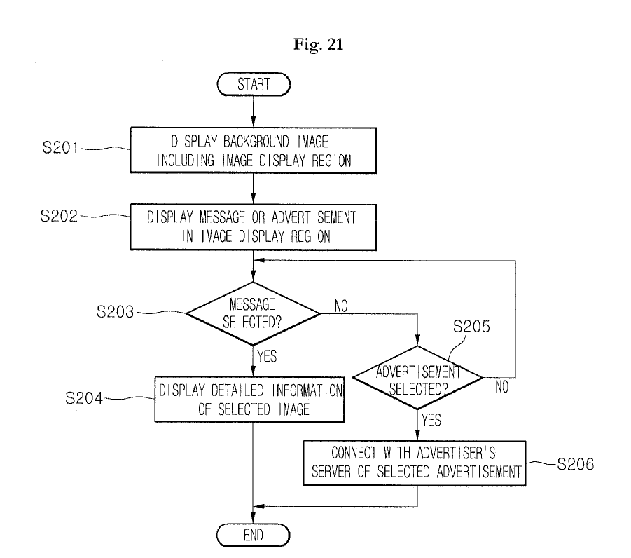

FIG. 21 is a flowchart showing operations included in a method of displaying an image or an advertisement on a menu screen, using the background image.

In step S201, a background image including an image display region where a message or an advertisement image can be displayed is displayed. The message may be a predetermined message for providing a user with information and the advertisement image may include a predetermined image that can be used for an advertisement, such as an advertisement expression and company logo, etc.

In step S202, a message or an advertisement image is displayed in the image display region. Steps S201 and S202 may be simultaneously performed. The message or the advertisement may be provided from the network operator or the content provider of FIG. 1, or a predetermined advertiser.

In step S203, it is determined whether a user selects the message. When the user has selected a message, information of the selected message is displayed in step S204.

When the user has not selected a message in step S203, it is determined whether to have selected an advertisement in step S205. When the advertisement has been selected, the server of the selected advertiser is connected in step S206. When the advertiser is a contents provider, contents can be provided after the sever of the advertiser is connected.

It stands by when the user does not select any one of the message and the advertisement. According to one embodiment, it is possible to automatically change the message or advertisement displayed in the image display region every predetermined time.

According to one embodiment, the menu screen may be composed of a plurality of layers, one layer may displays an image, and it is possible to transmits and display the effect generated by displaying the image to another layer. That is, it is possible to transmit the effect generated by one of the plurality of layers to another layer. It is possible to provide a user with an active and funny interesting menu screen by making a plurality of layers exchange effects with each other.

In the embodiment shown in FIG. 15, as a video about weather is executed, the background image and icons consecutively exchange effects. That is, as described with reference to FIG. 9, the menu screen can be composed of the layer 213 including the background image 201 and the layer 213′ including the icons 212.

When a user selects the icon 203 providing weather information, an image in which it snows is first displayed on the layer 213 including the background image 201. It is possible to transmit the effect generated when it snows to the layer including the icons 212. That is, it is possible to display a view 214 in which snow is collected on the icons while snow falls in the background image. This corresponds to an embodiment that displays an image on one of two different layers and transmits the effect generated by displaying the image to the icons 12 included in another layer.

When a use selects icon 203 providing weather information, the control unit of the network TV first displays an image in which it snows on the layer including the background image. Thereafter, the control unit estimates an image in which snows falls and collects on the icons in consideration of the size and position of the icons, and performs control for displaying the estimated image.

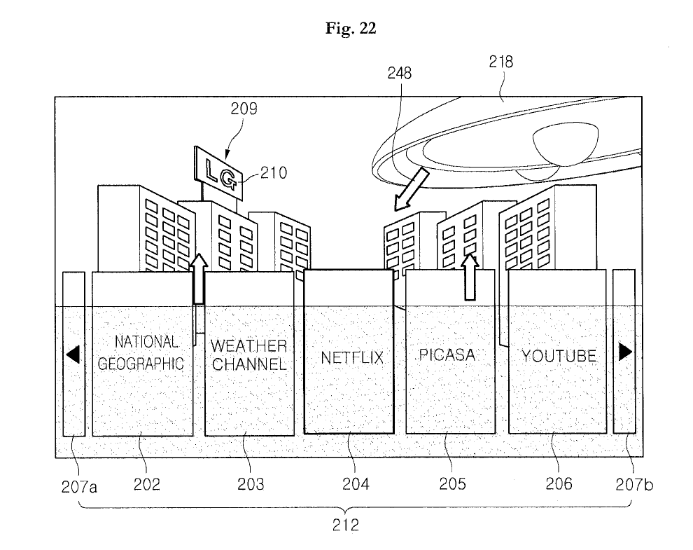

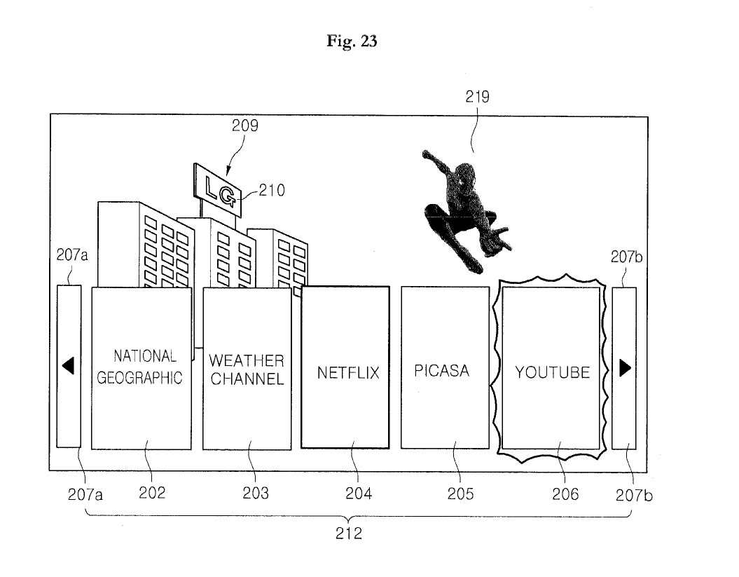

FIGS. 22 and 23 show embodiments that transmit effects among a plurality of layers according to an embodiment of the present invention.

Referring to FIG. 22, when a user selects the icon 204 of the contents provider providing movie contents, as shown in FIG. 22, an image in which an object in a movie, for example, a large spaceship 218 appears at the upper portion can be displayed. The image of the spaceship can be displayed on the layer including background image 201. It is possible to gradually darken the screen while a shadow of the spaceship gradually increases in size from the lower end of the background image and also gradually darken icons 212 from the lower end, as the spaceship moves in the direction of arrow 248. It is possible to display the shadow influencing icons 212 on the layer including the icons.

When an image in which the spaceship moves is displayed, the control unit of the network TV estimates a shadow image that will be displayed over icons 212 in consideration of the size and position of the icons and then displays the shadow over the icons on the basis of the estimated result.

Referring to FIG. 23, it is possible to shows an image in which a character of a movie, for example, spiderman 219 appears and makes an action hitting one 206 of the icons or shooting webs, when a user selects the icon 204 of the contents provider providing movie contents. The image of the spiderman is displayed on the layer including the background image. It is possible to display an image in which the icons 206 fall forward or the webs are entangled by an action of the spiderman. It is possible to display the image in which the icon 206 fall or the webs are entangled on the layer including the icon.

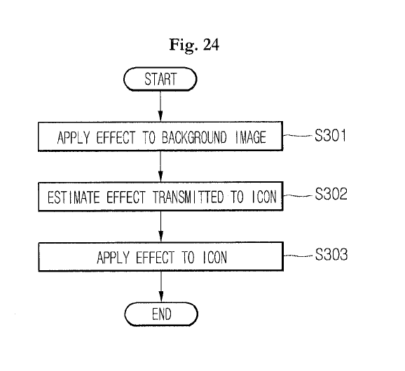

FIG. 24 shows a flowchart containing operations included in one embodiment of a method of transmitting an effect in accordance with image display between layers in a menu screen composed of a plurality of layers.

In step S301, a effect is applied to the layer including a background image, in the plurality of layers constituting the menu screen. That is, an image is displayed.

In step S302, as the effect applied to the background image appears, effects that will be transmitted to the icons or images that will be displayed are estimated, and in step S303, the estimated effects are applied to the icons.

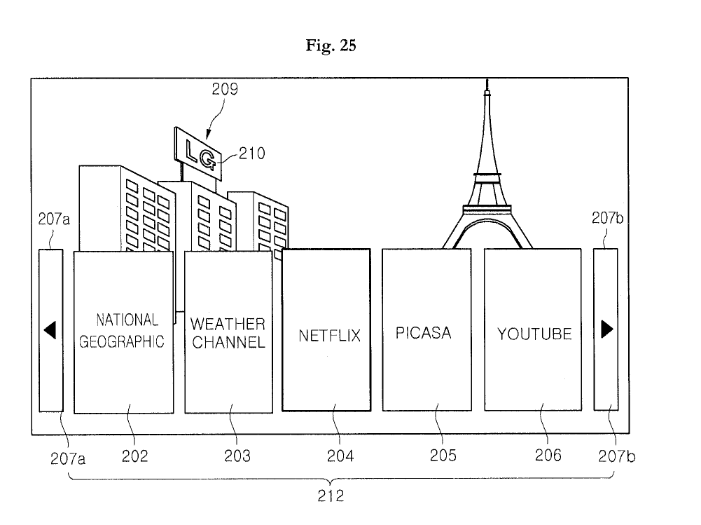

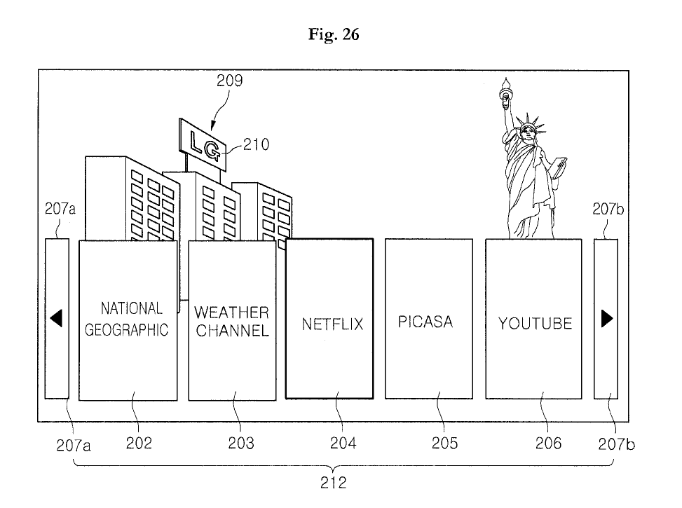

According to one embodiment, it is possible to acquire predetermined condition information of a user or the network TV, for example, information of the area of the user, time, or seasons, and then automatically changed the background image in accordance with the condition information. For example, when the area where a user is in Paris as shown in FIG. 25, it is possible to display a background image 201 including the Eiffel Tower, which is a landmark of Paris, and when it is New York, it is possible to display a background image 201 including the Statue of Liberty, as shown in FIG. 26. The area information of a user can be set by the user, or received from the network operator or the content provider 20 and stored in the network TV.

Further, it is possible to change the background image corresponding to the area information changed, when a user voluntarily changes the area information or moves out.

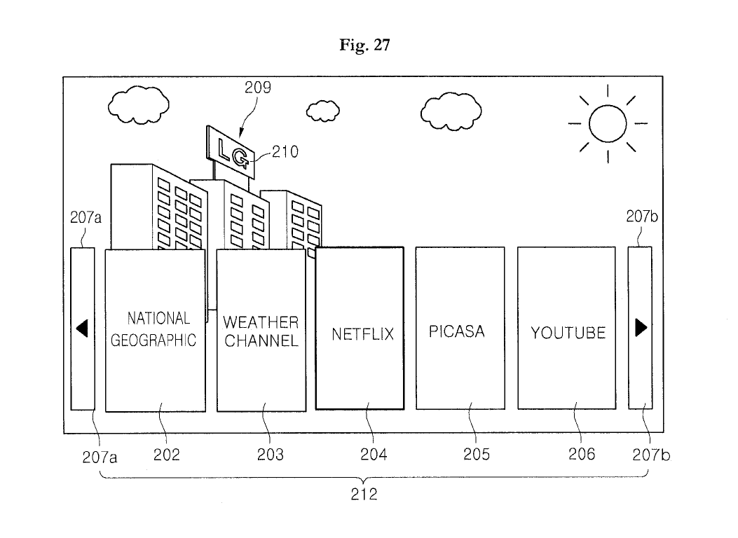

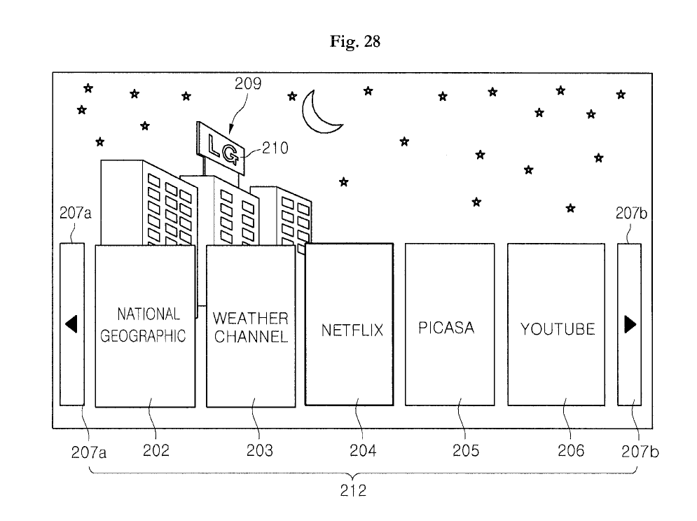

Further, as shown in FIGS. 27 and 28, it is possible to display a background image including the night view at night, or an image including the day view in the daytime, on the basis of the current time information.

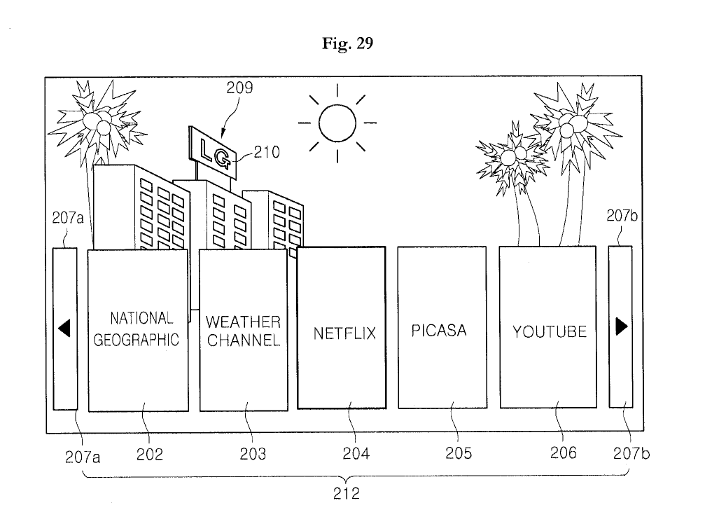

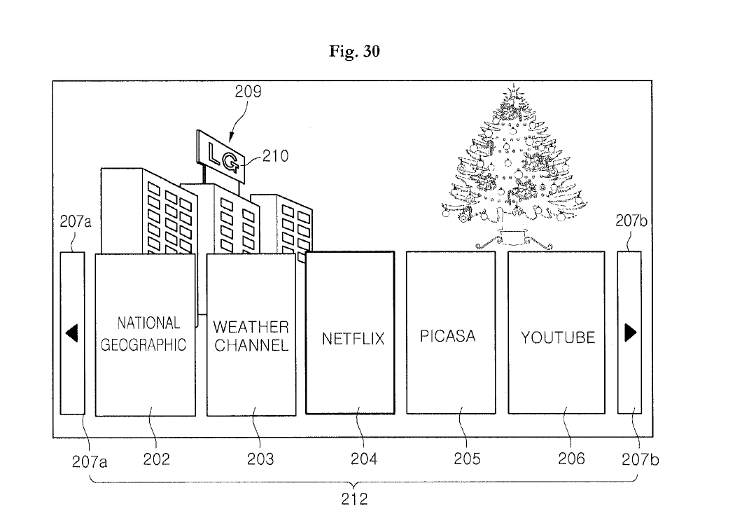

Further, it is possible to a background image including a view corresponding to each season in accordance with seasons. For example, it is possible to display a background image including a summer view in summer as shown in FIG. 29, and it is possible to display a background image including a winter view in winter as shown in FIG. 30.

The time information or weather information described above, that is, the date information may be received from the network operator and the contents provider, and may be extracted from a broadcast signal. In addition, it is possible to provide a user with an active menu screen by changing the background image in various ways in accordance with the condition information of the user or the network TV.

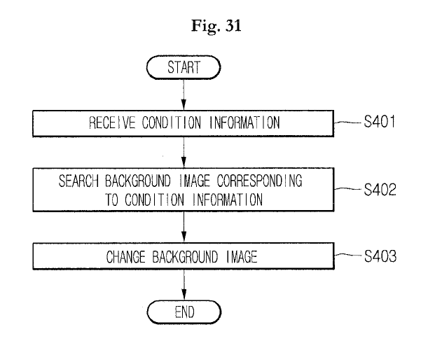

FIG. 31 is a flowchart showing operations included in one embodiment of a method of changing a background image in accordance with the condition information of a user or a network TV.

In step S401, a network TV receives condition information of a user or the network TV from the network operator or content provider. The condition information may include area information of a user, or time and date (season) information. The condition information can be extracted from a broadcast signal that the network TV has received.

In step S402, a background image corresponding to the condition information is searched.

In step S403, the background image is changed into the searched background image. It is possible not to change the background image, when the current displayed environment information consists with the background image. Further, the function may be inactivated, when a user does not want to change the background image.

Further, according to one embodiment, when a problem is detected while monitoring the service condition of each contents provider or the network condition of the network TV, it is possible to display the problem on the menu screen.

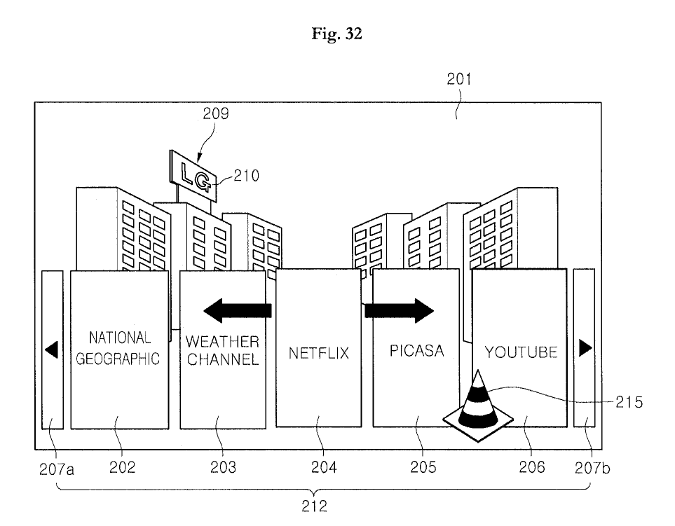

When a contents provider cannot provide a service due to server check, it is possible to display that service is unavailable on the menu screen. For example, as shown in FIG. 32, it is possible to display that service is unavailable on corresponding icon 206, in which, preferably, it is possible to display an intuitive image, for example, a graphic image 215, “under construction.”

Further, according to one embodiment, it is possible to the connection condition between the network TV and the content provider or the network operator on the menu screen.

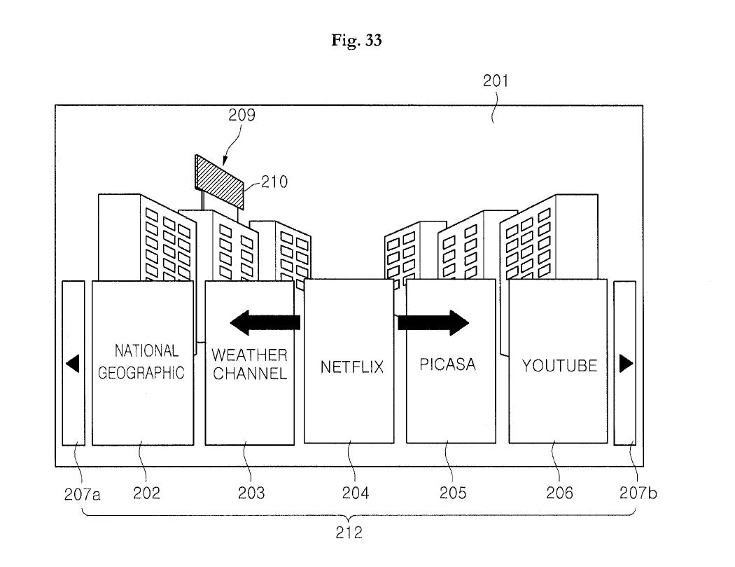

For example, as shown in FIG. 33, with the Netcast mode executed, it is possible to the brightness of advertisement image 210 displayed in image display region 209 included in the background image, in accordance with the network connection condition. That is, it is possible to brighten the advertisement image when the network connection condition is good, and it is possible to darken the advertisement image when the connection condition is bad. The above configuration can provide a user with interest, as compared with displaying the network condition by using a common text or graph etc.

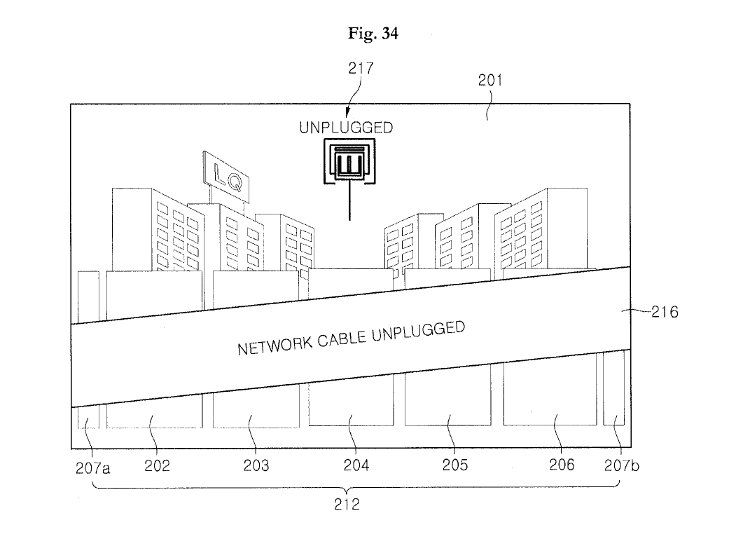

Further, according to one embodiment, when a user executes the Netcast mode and the network cable of the network TV is unplugged and the interface is not operated, as shown in FIG. 34, it is possible to display this condition throughout the menu screen. In this case, it is possible to display a menu screen that is more intuitive and provides a user with interest as compared with informing it with a common text, by displaying a predetermined graphic image 217 showing that the cable is unplugged, such as a block tape 216 in general construction sites, as shown in FIG. 34.

In this case, since the Netcast service of the network TV 30 is completely unavailable, it is possible to allow a user to intuitively know it by translucently or dimly displaying the images on the menu screen, that is, the background image and icons, except for expressions 216 and 217 informing that the network interface is not operated.

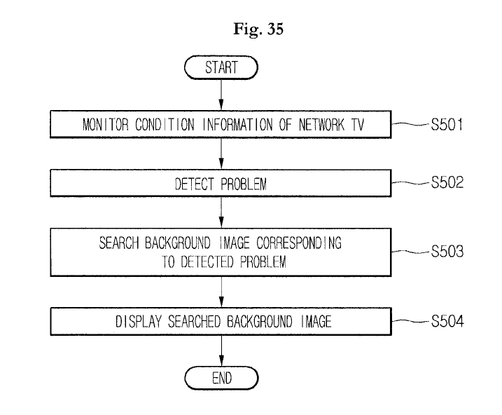

FIG. 35 is a flowchart showing operations included in one embodiment of illustrating a method of changing a menu screen in accordance with the condition of a contents provider or a network TV.

The condition information of the TV is monitored in step S501 and a problem is detected in step S502. A background image corresponding to the problem is searched in step S503 and the image corresponding to the detected problem is displayed in step S504.

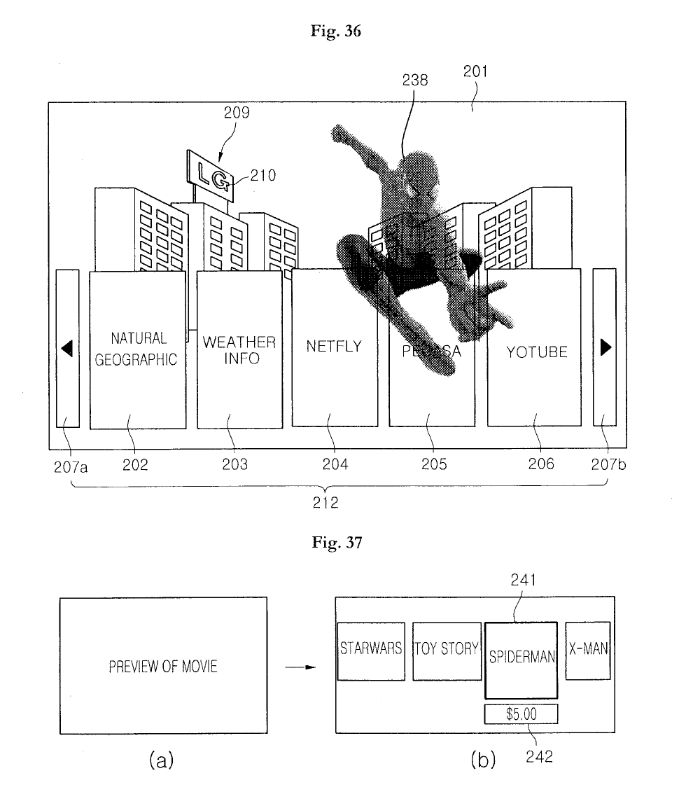

FIG. 36 illustrates one embodiment of an advertisement method. Referring to FIG. 36, after a predetermined time passes with a menu screen displayed, it is possible to display an advertisement image including characters and objects appearing in movie contents that will be advertised, regardless of a user's input. The advertisement image may be a video or an animation.

For example, when movie contents to advertise is “Spiderman”, it is possible to display a video in which a spiderman 238 flies out of the screen from one side of the screen in accordance with a predetermined condition, with the main screen displayed. The predetermined condition may be a predetermined time or may be when there is not user's input for a predetermined period of time. That is, an advertisement image can be displayed with the menu screen displayed at a predetermined time, and it is possible to display the advertisement image, when a user does not input anything for a predetermined period of time, with the menu screen displayed.

Preferably, the video of spiderman 238 is displayed in relation to background 201 or icons 212. That is, it is possible to display a video that seems as if the spiderman flies between buildings in the city shown in the background image. Alternatively, it is also possible to display a video in which the spiderman runs over structures of the icons.

The advertisement image may be received from an advertiser and then transmitted to the network TV of a user by the network operator, and a content provider may generate an advertisement image and transmits it to the network TV directly or through the network operator.

It is possible to transmit an advertisement image together with a condition for displaying advertisement image. It is possible to make the advertisement image in software type such that it can be displayed if a predetermined condition based on the system information of the network TV is satisfied, regardless of a user's input. According to one embodiment, a user can set the advertisement image not to be displayed. Further, the advertisement image can be implemented in a 3D-image.

According to one embodiment, when a user presses a specific button of a motion recognition remote controller, for example, an OK button, as shown in FIG. 37A, a preview (or a trailer) of a movie to advertise is displayed, and it is possible to display the price information 242 of the movie and the icon (highlighted) 241 showing a spiderman together with a list showing other movies, as shown in FIG. 37B, after the preview is finished. The icon 241 may be an image showing a movie icon, such as a DVD title, and may include information on the running time, characters, and synopsis of the movie.

In the state shown in FIG. 37B, when the user presses a specific button, for example, the OK button, a contents purchase screen of Spiderman appears, such that the movie contents of Spiderman can be supplied to the user's network TV. Further, in the state shown in FIG. 37B, user can select other movies by adjusting a direction key. The selected movie list is highlighted, and when the user presses the OK button after selecting a movie, the screen changes into a movie purchase screen, such that the selected movie contents can be supplied to the user's network TV.

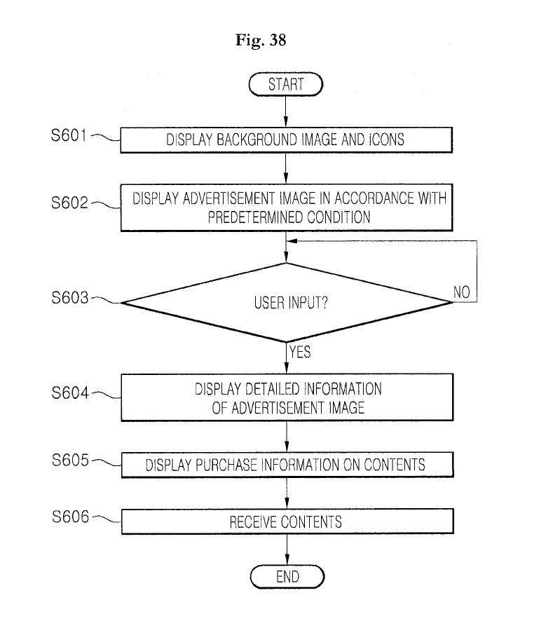

FIG. 38 is a flowchart showing operations included in one embodiment of a method of displaying an advertisement image, regardless of user's selection, after a predetermined time passes with a menu screen including the background image 201 and the icons 212 displayed.

In step S601, a menu screen including a background image and icons is displayed.

In step S602, an advertisement image is displayed, regardless of whether there is a user input. The advertisement image may relate to the background image or the icons. That is, when an advertisement is an advertisement of movie content, it is possible to display an image in which the characters and objects in the movie move in the background image or on the icons. When the user presses a specific button, for example, an OK button while the advertisement image is displayed in step S603, step S604 is performed. It stands by when there is no input.

In step S604, the server of the content provider of the selected icon is connected.

In step S605, the detailed information of the advertisement is displayed. When the advertisement relates to movie contents, the detailed information may be the preview of the movie, and when it relates to other content, it may be an advertisement video relating to the corresponding contents.

In step S606, purchase information on the contents to advertise is displayed.

In step 607, contents are provided in accordance with a service that is provided by a common network TV.

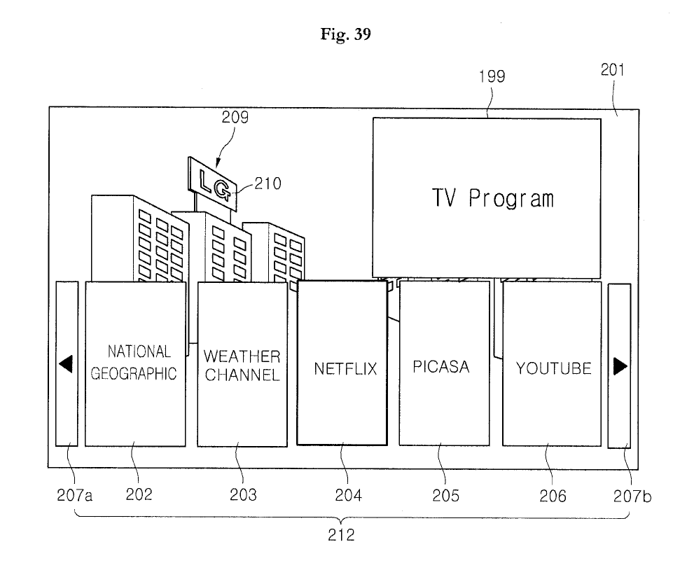

In accordance with another embodiment shown in FIG. 39, a television signal containing a television program 199 may be displayed at the same time the menu screen containing the background image and content provider icons is displayed. The television program 199 may be displayed at a fixed or adjustable region in the background image or at another location within the menu screen or at an area outside of the menu screen, for example, in a picture-in-picture signal area of the television screen.

One or more of the foregoing embodiments may be implemented by a program that is executed by a common processor, such as a computer, and may be implemented by using particularly a flash application or a 3D-flash application. The implemented program can be stored in a recording medium in the network TV which a computer can read. Examples of the computer-readable recording media include a ROM, a RAM, a CD-ROM, a magnetic tape, a floppy disk, an optical data storage etc. and in addition, include a recording medium implemented in the form of a carrier wave (for example, transmission through the Internet).

Further, the computer-readable recording media are distributed on computer systems connected through the network, and thus the computer-readable recording media may be stored and executed as the computer-readable code by a distribution scheme. Further, functional programs, codes, and code segments for implementing a method of receiving broadcast can be easily inferred by programmers in the related art.

Other than the embodiments described above, there may be content providers who provide various types of contents in a network TV according to the embodiments described herein, and the videos relating to contents that are displayed every time the icons of the content providers are selected can be changed.

One object of the embodiments described herein is to display a new type of menu and allows a user to select it in a network TV system. Another object is to provide an advertising method that does not bore users and is more useful for advertisers, in a network TV system. Another object is to provide a method of providing an advertisement image or information which relate to a background image when the background image is displayed, in a network TV system.

A display device that is connectable with a network according to one embodiment includes: a network interface unit that connects with a contents provider server and a network operator through the network and receives contents and advertisement images; a user interface unit that receives a user's input; a control unit that displays a background image including at least one advertisement region for displaying an advertisement image and at least one icon representing the content provider, and performs control for displaying an advertisement image in the advertisement region; and a display unit that displays the background image and the icons in accordance with the control unit.

A display device that is connectable with a network according to an embodiment includes: a network interface unit that connects with a contents provider server and a network operator through the network and receives contents and advertisements; a user interface unit that receives a user's input; a control unit that displays a background image and icons representing contents providers and performs control for displaying an advertisement image that the contents providers or a network operator can control in accordance with a predetermined condition; and a display unit that displays the menu screen and advertisement image in accordance with the control of the control unit.

An advertisement method that uses a display device connected with at least one content provider through a network according to an embodiment includes: displaying a background image including at least one advertisement region where an advertisement image is displayed and at least one icon that represents the contents provider; and displaying an advertisement image in the advertisement region.

An advertisement method that uses a display device connected with at least one content provider and a network operator through a network according to an embodiment includes: displaying a background image and at least one icon that represents the contents provider; and displaying an advertisement image that can be controlled by the network operator or the contents provider in accordance with a predetermined condition.

According to one or more embodiments described herein, it is possible to provide a user with a new type of method of displaying and selecting a menu in a network TV system. According to one or more embodiments described herein, it is possible to provide an advertisement method that is not boring for a user and is more effective for an advertiser, in a network TV system.

According to one or more embodiments described herein, it is possible to provide a method of providing an advertisement image or information relating to a background image, with the background image displayed in a network TV system.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments, it should be understood that numerous other modifications and/or combinations of the embodiments described herein can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An information manager comprising:
a network interface to establish a connection with at least one of a server of a content provider or a network operator and to receive content and one or more advertisement images through a network;
a user interface to receive a signal initiated by a user; and
a controller to control display of a plurality of icons and a background image that includes at least one advertisement region, wherein one of the advertisement images is displayed in said region and wherein one of the icons corresponds to the content provider.

2. The information manager of claim 1, wherein the background image and the icons are displayed when an operation mode is activated which allows for selection of the icon corresponding to the content provider.

3. The information manager of claim 1, wherein said region is located at a predetermined fixed position in the background image.

4. The information manager of claim 1, wherein a location of said region is adjustable within or relative to the background image.

5. An information manager comprising:
a network interface to establish a connection with at least one of a server of a content provider or a network operator, and to receive content and advertisement information through a network;
a user interface to receive a signal initiated by a user;
a controller to control simultaneous display of:
(1) a background image,
(2) a plurality of icons corresponding to a respective plurality of content providers, and
(3) advertisement information provided or controlled by one or more of the content providers or the network operator, wherein the advertisement information is displayed based on a predetermined condition and the plurality of icons are displayed in menu form.

6. The information manager of claim 5, wherein the advertisement information includes an image indicative of movie contents, said image including at least one of characters or objects corresponding to the movie contents.

7. The information manager of claim 5, wherein the controller controls output of additional information on said image based on a signal received from a user during display of the image.

8. The information manager of claim 5, wherein the background image and icons are displayed when an operation mode is activated that allows for one of the icons to be selected and connection to the content provider of the selected icon.

9. The information manager of claim 5, further comprising:
a broadcast signal processor that receives and processes a broadcast signal for output, wherein the broadcast signal is output at a same time the background image and icons are displayed.

10. An method for managing display of information, comprising:
displaying a background image that includes at least one region for displaying advertisement information;
displaying an advertisement image in the advertisement region; and
displaying a plurality of icons simultaneously with the background image, the plurality of icons corresponding to a respective plurality of content providers.

11. The method of claim 10, further comprising:
receiving a signal selecting the advertisement image; and
displaying information corresponding to the advertisement image in response to said signal.

12. The method of claim 10, wherein the background image and icons are displayed when an operation mode is activated that allows for selection of one of the icons and establishment of a connection with a corresponding one of the content providers.

13. The method of claim 10, wherein the advertisement image is received from one of the content providers.

14. The method of claim 10, wherein the advertisement region is located at a predetermined fixed position in the background image.

15. The method of claim 10, wherein the advertisement region is displayed at a position that is adjustable within or relative to the background image.

16. A method for controlling display of information, comprising:
displaying a background image and a plurality of icons that correspond to a respective plurality of content providers; and
displaying an advertisement image from a network operator or the content provider based on a predetermined condition.

17. The method of claim 16, further comprising:
receiving a signal corresponding to key input from a user; and
outputting information corresponding to the advertisement image in response to the key input signal.

18. The method of claim 16, wherein the advertisement image is included in a video that corresponds to an advertisement of a movie, said video including at least one of characters or objects corresponding to the movie.

19. The method of claim 17, wherein the advertisement image corresponds to a movie and the output information includes a preview of the movie.

20. The method of claim 16, wherein the background image and the icons are displayed when an operation mode is activated for selecting and connecting with one of the content providers.
